(19) United States
(12) Patent Application Publication
(10) Pub. No.: US 2026/0146663 A1
(43) Pub. Date: May 28, 2026

(54) Transmission system for electric vehicles with position feedback control and control method of transmission system

(71) Applicant: NEOOTO CO., LTD., Seoul (KR)

(72) Inventor: Sa Ro KIM, Chungcheongnam-do (KR)

(73) Assignee: NEOOTO CO., LTD., Seoul (KR)

(21) Appl. No.: 19/000,733

(22) Filed: Dec. 24, 2024

(30) Foreign Application Priority Data
Nov. 28, 2024 (KR) 10-2024-0173934

(51) Int. Cl. F16H 3/089; F16H 57/02; F16H 59/68; F16H 61/04; F16H 61/12; F16H 63/24; F16H 63/30; F16H 63/32

(52) U.S. Cl. CPC F16H 3/089; F16H 57/02; F16H 59/68; F16H 61/0403; F16H 61/12; F16H 63/24; F16H 63/304; F16H 63/32; F16H 2057/02026; F16H 2057/02043; F16H 2061/1288

(57) ABSTRACT

Provided is a transmission system including an output axis, a plurality of input gears mounted on the output axis, a transmission assembly configured to selectively engage with the plurality of input gears, and a controller, wherein the transmission assembly includes a plurality of actuators, a plurality of rotation axes, a plurality of shift forks, a plurality of synchronizers, and a plurality of position sensors, wherein the controller is configured to compare a position value of the plurality of shift forks detected by the plurality of position sensors and a predetermined reference position value and, when the detected position value does not match the reference position value, transmit a correction signal to at least one of the plurality of transmission actuators.

### CROSS-REFERENCE TO RELATED APPLICATION

This application is based on and claims priority under 35 U.S.C. § 119 to Korean Patent Application No. 10-2024-0173934, filed on Nov. 28, 2024, in the Korean Intellectual Property Office, the disclosure of which is incorporated by reference herein in its entirety.

### Technical Field The present disclosure relates to a transmission system for electric vehicles with position feedback control and a control method of the transmission system.

### Background Art

Precisely controlling the position of shift forks through conventional transmission systems for electric vehicles is difficult due to mechanical errors between gears caused by backlash and jamming of gears. In addition, these mechanical errors may cause shock and noise during gear shifting operations, which reduce driving stability. Also, during a process of moving the shift forks, relatively large forces are applied to upper portions of the shift forks connected to actuators, thereby causing the shift forks to bend or fail to properly connect to synchronizers. In addition, shifting operations become less than smooth because the positions of the shift forks are not adjusted while the shift forks are not properly connected to the synchronizers.

The information disclosed in the description of the related art is only intended to improve the understanding of the background of the disclosure, and thus, may include information that does not constitute the related art.

### SUMMARY OF INVENTION

Provided are a transmission system for an electric vehicle with position feedback control and a control method of the transmission system according to embodiments, wherein the transmission system may detect a position of a shift fork in real time and feedback control the position of the shift fork, thereby increasing the precision of the transmission position and reducing shock and noise.

However, the technical problems to be solved by the embodiments of the disclosure are not limited to the problems described above, and other problems not mentioned may be clearly understood by one or ordinary skill in the art from the description below.

According to one or more embodiments, a transmission system may include an output axis, a plurality of input gears mounted on the output axis, a transmission assembly configured to selectively engage with the plurality of input gears, and a controller, wherein the transmission assembly may include a plurality of transmission actuators including a first transmission actuator and a second transmission actuator, a plurality of rotation axes including a first rotation axis connected to the first transmission actuator and a second rotation axis connected to the second transmission actuator, the plurality of axes each extending in a first direction, a plurality of shift forks including a first shift fork connected to the first rotation axis and a second shift fork connected to the second rotation axis, a plurality of synchronizers including a first synchronizer supported by the first shift fork and configured to selectively engage with the plurality of input gears and a second synchronizer supported by the second shift fork and configured to selectively engage with the plurality of input gears, and a plurality of position sensors including a first position sensor configured to detect a position of the first shift fork and a second position sensor configured to detect a position of the second shift fork, and the controller is configured to compare a position value of the plurality of shift forks detected by the plurality of position sensors and a predetermined reference position value and, when the detected position value does not match the reference position value, transmit a correction signal to at least one of the plurality of transmission actuators. Accordingly, the transmission system may feedback control the position of the shift fork such that the synchronizer is precisely engaged with the input gear, thereby allowing a steady shifting operation.

The transmission assembly may further include a plurality of jigs including a first jig connected to and configured to move together with the first shift fork and a second jig connected to and configured to move together with the second shift fork, and the plurality of position sensors may be configured to detect a position of each of the plurality of jigs to detect a position of the plurality of shift forks. Accordingly, the transmission system may detect the position of the shift fork based on the position of the jig while not affecting the transmission operation of the shift fork and, based on the detection, may feedback control the shift fork.

The plurality of jigs may be respectively mounted on upper surfaces of the plurality of shift forks, extend in a second direction crossing the first direction, and include holes in the upper portions into which at least a portion of the plurality of position sensors are respectively inserted. Accordingly, the transmission system may steadily support the position sensor on the jig.

According to one or more embodiments, the transmission system may further include a housing and a plurality of sensor boxes mounted on the housing and accommodating the plurality of position sensors. Accordingly, the transmission system may allow the position sensor to not interfere with another element.

The plurality of position sensors may include a linear variable displacement transducer (LVDT) sensor, and the plurality of position sensors may each include a core movable together with the jig and a plurality of coils that are not moved by the jig and surround the core. Accordingly, the transmission system may have higher precision than a non-contact sensor even without using an oil and may allow the position sensor to not affect the movement of the shift fork.

A first worm gear may be included in an outer surface of the first rotation axis, a second worm gear may be included in an outer surface of the second rotation axis, the first shift fork may include a first rack gear engaged with the first worm gear, the second shift fork may include a second rack gear engaged with the second worm gear, and the first rack gear and the second rack gear may face opposite directions. Accordingly, the transmission system may be reduced in size and mechanical errors such as backlash and gear misalignment may be reduced.

The transmission system may further include a rotation sensor configured to detect the rotation speed of the output axis and, when the detected position value matches the reference position value, the controller may determine whether the rotation speed of the output axis detected by the rotation sensor matches the predetermined reference rotation speed of the output axis, and, when the detected rotation speed does not match the reference rotation speed, the controller may transmit a correction signal to the plurality of transmission actuators. Accordingly, the transmission system may precisely perform transmission through rotation speed feedback control, in addition to position feedback control.

According to one or more embodiments, a method of controlling a transmission system includes transmitting, by a controller, a transmission signal to a transmission actuator, selectively engaging, by the transmission actuator, a synchronizer supported by a shift fork with a plurality of input gears mounted on an output axis, detecting, by a position sensor connected to the shift fork, a position of the shift fork, comparing, by the controller, a position value of the shift fork detected by the position sensor and a predetermined reference position value, and transmitting, by the controller, a correction signal to the transmission actuator when the detected position value does not match the reference position value.

In the transmitting of the correction signal to the transmission actuator, when the detected position value of the shift fork is less than the predetermined reference position value, the controller may be configured to transmit the correction signal to the transmission actuator such that the transmission actuator rotates in a same direction as the transmission signal, and, when the detected position value of the shift fork is greater than the predetermined reference position value, controller may be configured to transmit the correction signal to the transmission actuator such that the transmission actuator rotates in an opposite direction to the transmission signal.

According to one or more embodiments, the method of controlling the transmission system may include comparing, by the controller, the rotation speed of the output axis detected by the rotation sensor with the predetermined reference rotation speed of the output axis when the detected position value matches the reference position value, and transmitting, by the controller, a correction signal to the transmission actuator when the detected rotation speed does not match the reference rotation speed.

The effects obtainable from the disclosure are not limited to the above, and other technical effects that are not mentioned may be clearly understood by one of ordinary skill in the art through the detailed description below.

### BRIEF DESCRIPTION OF DRAWINGS

The above and other aspects, features, and advantages of certain embodiments of the disclosure will be more apparent from the following description taken in conjunction with the accompanying drawings.

FIG. 1 schematically shows an electric vehicle including a transmission system according to some embodiments.

FIG. 2 shows an appearance of a transmission system according to some embodiments.

FIG. 3 schematically shows a transmission system according to some embodiments.

FIG. 4 shows a perspective view of a transmission assembly according to some embodiments.

FIG. 5 shows a plan view of a transmission assembly according to some embodiments.

FIG. 6 to FIG. 10 show transmission operations of a transmission assembly according to some embodiments.

FIG. 11 and FIG. 12 show driving orders of a transmission assembly according to some embodiments.

### DESCRIPTION OF EMBODIMENTS

Aspects of some embodiments of the present disclosure and methods of accomplishing the same may be understood more readily by reference to the detailed description of embodiments and the accompanying drawings. Hereinafter, embodiments will be described in more detail with reference to the accompanying drawings. The described embodiments, however, may have various modifications and may be embodied in different forms, and should not be construed as being limited to only the illustrated embodiments herein. Further, each of the features of the various embodiments of the present disclosure may be combined or combined with each other, in part or in whole, and technically various interlocking and driving are possible. Each embodiment may be implemented independently of each other or may be implemented together in an association. The described embodiments are provided as examples so that this disclosure will be thorough and complete, and will fully convey the aspects of the present disclosure to those skilled in the art, and it should be understood that the present disclosure covers all the modifications, equivalents, and replacements within the idea and technical scope of the present disclosure. Accordingly, processes, elements, and techniques that are not necessary to those having ordinary skill in the art for a complete understanding of the aspects of the present disclosure may not be described.

Unless otherwise noted, like reference numerals, characters, or combinations thereof denote like elements throughout the attached drawings and the written description, and thus, descriptions thereof will not be repeated. Further, parts that are not related to, or that are irrelevant to, the description of the embodiments might not be shown to make the description clear.

In the drawings, the relative sizes of elements, layers, and regions may be exaggerated for clarity. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of regions, but are to include deviations in shapes that result from, for instance, manufacturing.

For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Thus, the regions illustrated in the drawings are schematic in nature and their shapes are not intended to illustrate the actual shape of a region of a device and are not intended to be limiting. Additionally, as those skilled in the art would realize, the described embodiments may be modified in various ways, all without departing from the spirit or scope of the present disclosure.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form to avoid unnecessarily obscuring various embodiments.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing particular embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

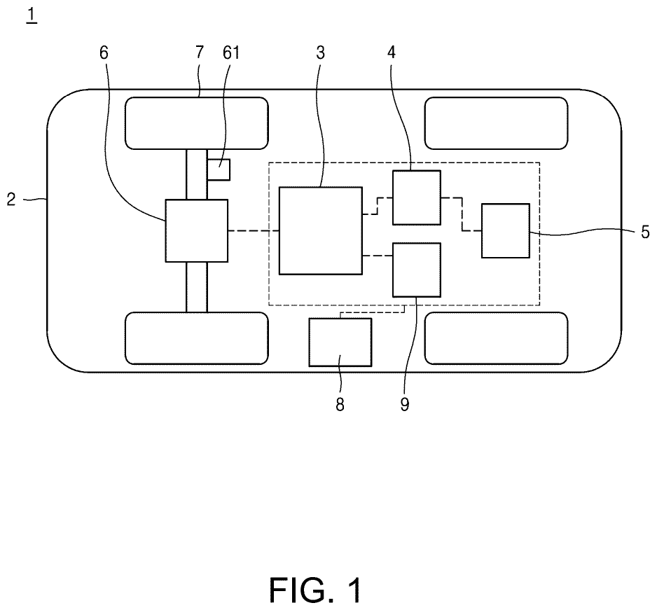

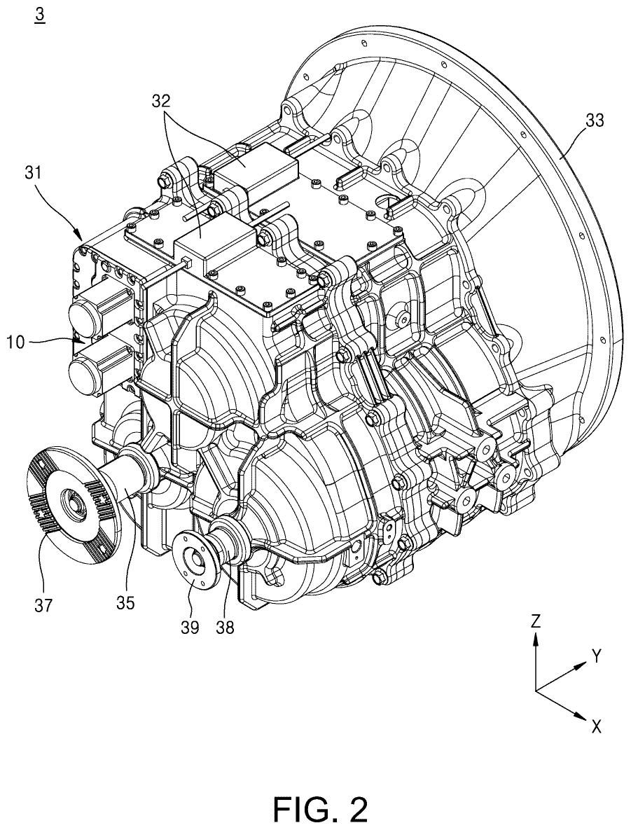

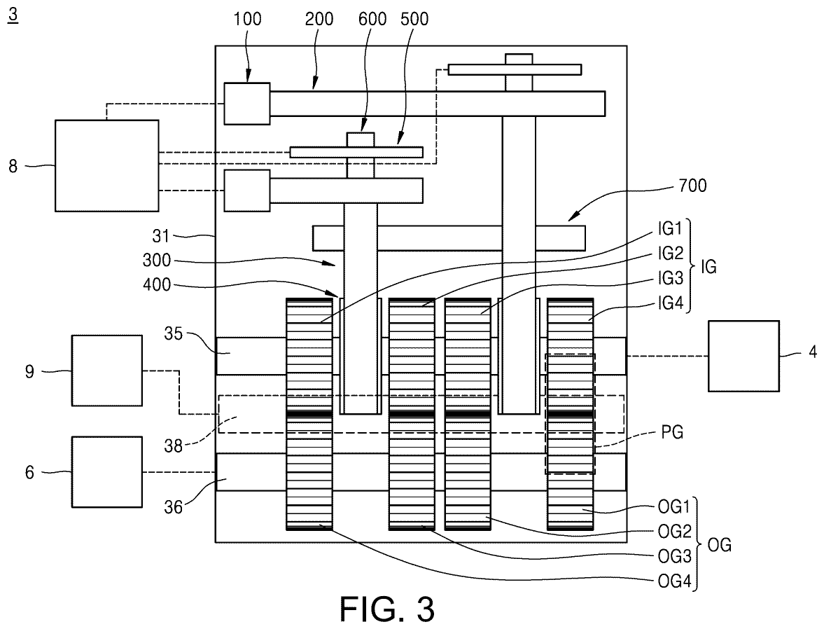

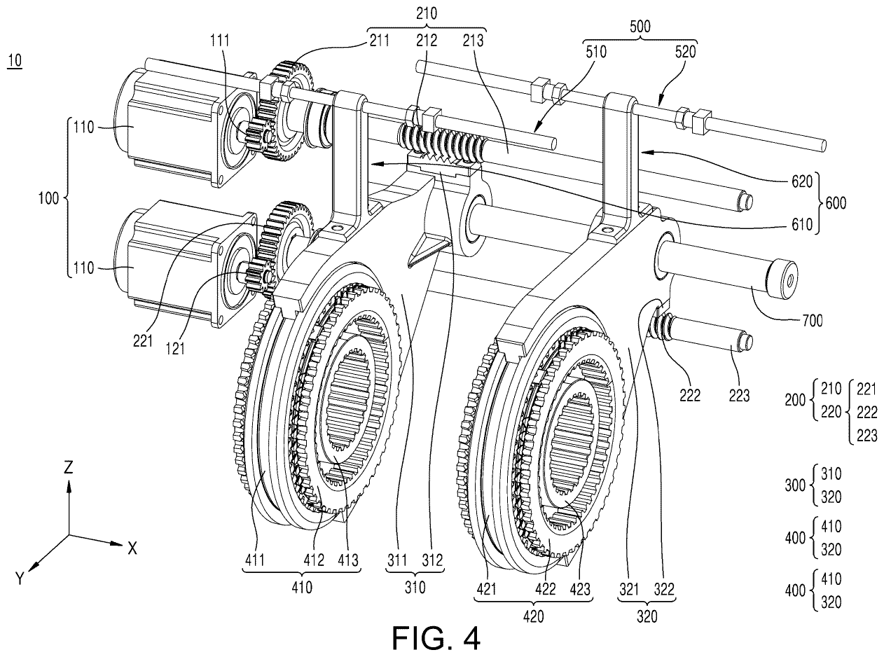

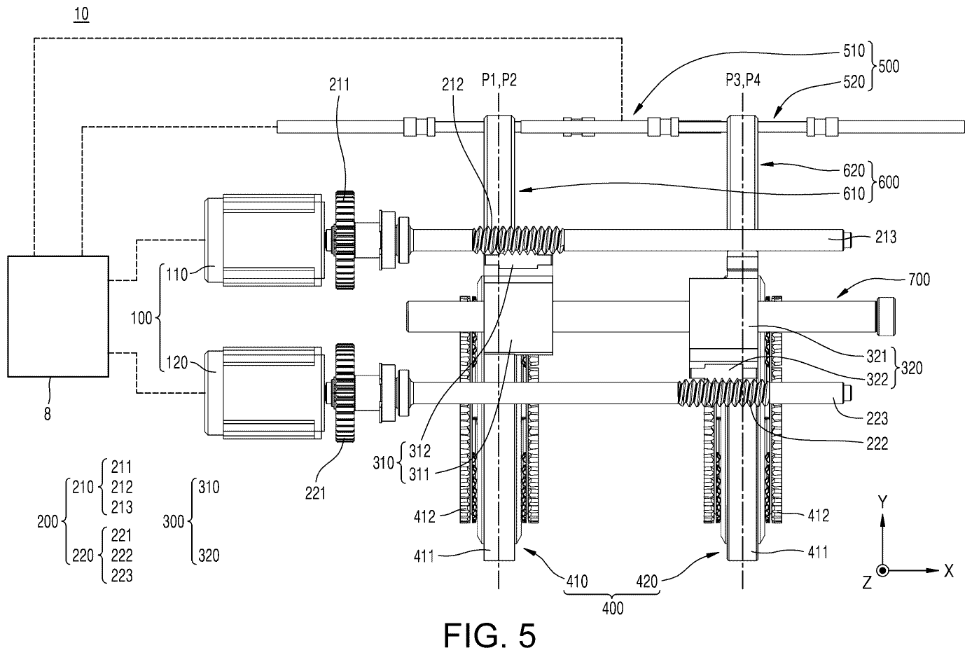

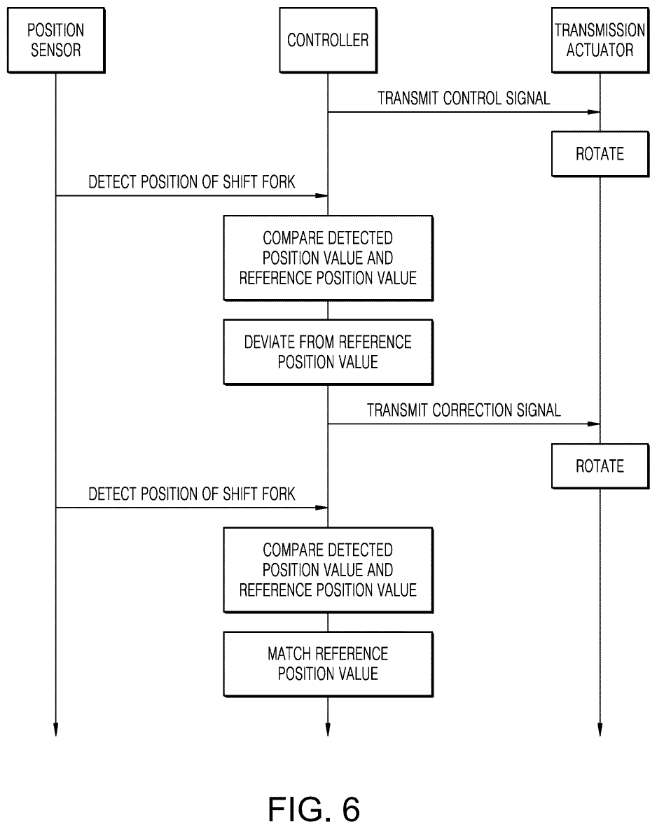

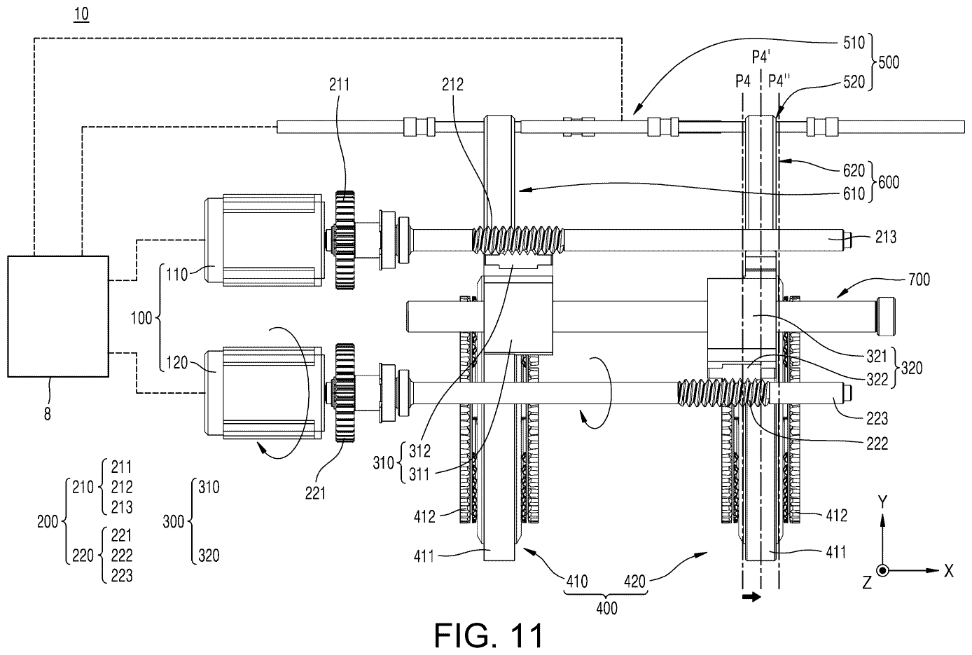

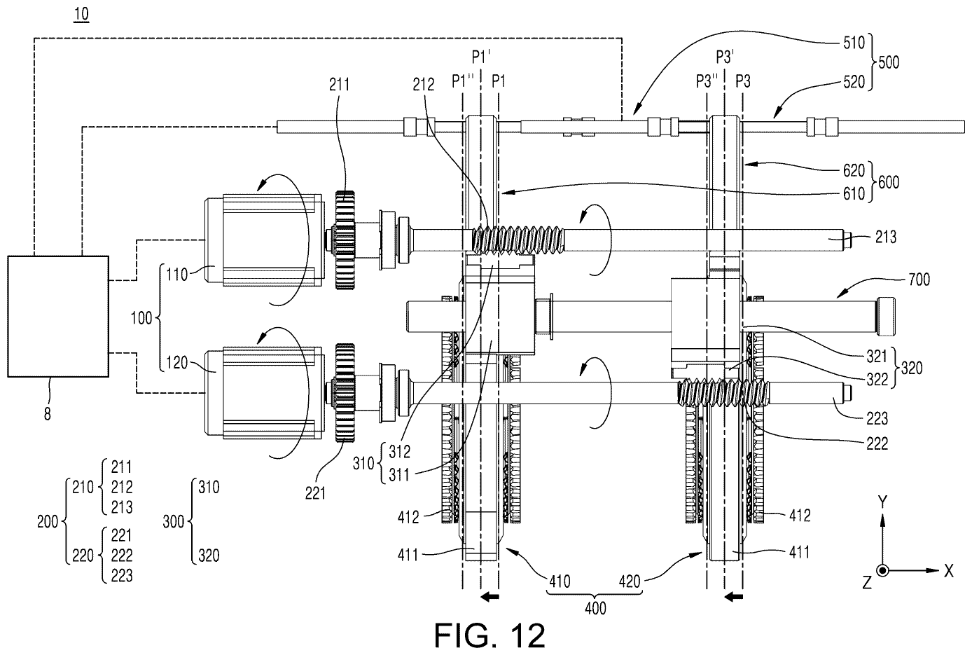

FIG. 1 schematically shows an electric vehicle 1 including a transmission system 3 according to some embodiments, FIG. 2 shows an appearance of the transmission system 3 according to some embodiments, FIG. 3 schematically shows the transmission system 3 according to some embodiments, FIG. 4 shows a perspective view of a transmission assembly 10 according to some embodiments, FIG. 5 shows a plan view of the transmission assembly 10 according to some embodiments, FIG. 6 to FIG. 10 show transmission operations of the transmission assembly 10 according to some embodiments, and FIG. 11 and FIG. 12 show driving orders of the transmission assembly 10 according to some embodiments.

The electric vehicle 1 may include the transmission system 3 according to some embodiments. For example, as shown in FIG. 1, the electric vehicle 1 may include a frame 2, the transmission system 3 accommodated in the frame 2, a driving motor 4 that drives the transmission system 3, a battery 5 configured to supply power to the driving motor 4, a differential device 6 that is shifted by the transmission system 3, a plurality of wheels 7 connected to the differential device 6, and a controller 8 configured to control the transmission system 3, the driving motor 4, and the battery 5. Alternatively, the electric vehicle 1 may further include a power take-off (PTO) device 9 that is connected to the transmission system 3 and that may take power from the electric vehicle 1 to the outside. When the battery 5 supplies power to the driving motor 4 and the driving motor 4 operates, power is transmitted to the differential device 6 through the transmission system 3 such that the wheel 7 (e.g., front wheels) may rotate. The transmission system 3 may perform a transmission operation by receiving a control signal from the controller 8 and operating a transmission actuator 100. Accordingly, the differential device 6 may be shifted. Alternatively, the transmission system 3 may receive a control signal from the controller 8 to operate the transmission actuator 100, thereby transmitting the power of the driving motor 4 to the PTO device 9 for the power to be used for an external device rather than for driving the electric vehicle 1.

The differential device 6 may include a rotation sensor 61. The rotation sensor 61 may sense the rotation speed of the rotation axis or wheel 7 of the differential device 6 shifted by the transmission system 3 and transmit the detected rotation speed to the controller 8. The controller 8 may determine whether the rotation speed detected by the rotation sensor 61 matches the reference speed and control the transmission system 3.

The transmission system 3 may include an output axis 36, a plurality of input gears IG mounted on the output axis 36, a transmission assembly 10 selectively engaged with the plurality of input gears IG, and a controller 8, wherein the transmission assembly 10 includes a plurality of transmission actuators 100 each including a first transmission actuator 110 and a second transmission actuator 120, a plurality of rotation axes 200 each including a first rotation axis 210 connected to the first transmission actuator 110 and a second rotation axis 220 connected to the second transmission actuator 120 and extending in a first direction, a plurality of shift forks 300 each including a first shift fork 310 connected to the first rotation axis 210 and a second shift fork 320 connected to the second rotation axis 220, a plurality of synchronizers 400 each including a first synchronizer 410 supported by the first shift fork 310 and selectively engaged with the plurality of input gears IG and a second synchronizer 420 supported by the second shift fork 320 and selectively engaged with the plurality of input gears IG, and a plurality of position sensors 500 including a first position sensor 510 sensing a position of the first shift fork 310 and a second position sensor 520 sensing a position of the second shift fork 320, wherein the controller 8 may compare the position value of the plurality of shift forks 300 sensed by the plurality of position sensors 500 and may transmit a correction signal to at least one of the plurality of transmission actuators 100 when the sensed position value does not match the reference position value.

The transmission system 3 according to some embodiments may include a transmission assembly 10, a housing 31, a sensor box 32, a motor flange 33, an input axis 35, an output axis 36, an output axis flange 37, an input gear IG, and an output gear OG.

The transmission assembly 10 is accommodated in and/or supported by the transmission system 3 and transmits power supplied from the driving motor 4 to the output axis 36 or a PTO axis 38 and may perform a transmission operation by controlling the rotation speed of the output axis 36. The transmission assembly 10 is described below.

The housing 31 may accommodate and/or support other elements of the transmission system 3 (e.g., the sensor box 32, the motor flange 33, the input axis 35, the output axis 36, the output axis flange 37, the input gear IG, and the output gear OG). The housing 31 may be connected to or mounted on the driving motor 4, the differential device 6, and the like.

The sensor box 32 may be mounted on the housing 31 and may accommodate and/or support the position sensor 500 of the transmission assembly 10. For example, as shown in FIG. 2, the sensor box 32 is mounted on the outer surface of the housing 31, and at least a portion of the position sensor 500 (e.g., a measuring portion or a coil and a core) may be accommodated in the sensor box 32. The sensor box 32 may be mounted on a position corresponding to the shift fork 300 and a jig 600 of the housing 31. Accordingly, the position sensor 500 may be supported by the sensor box 32 and detect a position of the jig 600 that is moved by the shift fork 300. The sensor box 32 may include a plurality of sensor boxes 32. For example, as shown in FIG. 2, the sensor box 32 may include two sensor boxes 32 and the number of sensor boxes 32 may be equal to the number of shift forks 300 and/or jigs 600.

The motor flange 33 may be provided on the driving motor 4 side of the housing 31. The motor flange 33 connects or mounts the transmission system 3 to or on the driving motor 4, and the input axis 35 to which power is transmitted from the driving motor 4 may be provided on the motor flange 33 side.

The input axis 35 may transmit power from the driving motor 4 to the transmission system 3. For example, as shown in FIG. 3, the input axis 35 may be connected to the driving motor 4 and a plurality of input gears IG may be mounted on the outer surface of the input axis 35. Additionally, the input axis 35 may be inserted into the shift fork 300 of the transmission assembly 10. As the shift fork 300 moves along the input axis 35, the shift fork 300 may be selectively engaged with the plurality of input gears IG to achieve a transmission operation. The plurality of input gears IG may include a first input gear IG1, a second input gear IG2, a third input gear IG3, and a fourth input gear IG4.

The output axis 36 may be connected to the differential device 6 and may transmit the power of the driving motor 4 to the differential device 6. For example, as shown in FIG. 3, a plurality of output gears OG may be mounted on the outer surface of the output axis 36. The rotation speed of the output axis 36 may be varied as the plurality of output gears OG are selectively coupled to the plurality of input gears IG. The plurality of output gears OG may include a first output gear OG1, a second output gear OG2, a third output gear OG3, and a fourth output gear OG4. Each output gear OG may be selectively engaged with each input gear IG by the movement of the shift fork 300. Each output gear OG may have different dimensions, thereby varying the rotation speed of the output axis 36 according to the coupling of the output gear OG and the input gear IG. For example, an N-speed may be a state in which no input gear IG is engaged with the output gear OG. In addition, the state in which the first input gear IG1 is engaged with the first output gear OG1 may be a 1-speed, the state in which the second input gear IG2 is engaged with the second output gear OG2 may be a 2-speed, the state in which the third input gear IG3 is engaged with the third output gear OG3 may be a 3-speed, and the state in which the fourth input gear IG4 is connected to the fourth output gear OG4 may be a 4-speed. In addition, the state in which the first shift fork 310 and the second shift fork 320 are respectively connected to the input gear IG may be a P-speed. In the present embodiment, four input gears IG and four output gears OG are illustrated, but the number of input gears IG and output gears OG is not particularly limited. The number of input gears IG and output gears OG according to some embodiments may each be 3 or less or 5 or more.

The output axis flange 37 may accommodate and support the output shaft 36 and support the output axis 36 on other elements. For example, as shown in FIG. 2, the output axis flange 37 may be on the opposite side of the motor flange 33 of the housing 31.

Alternatively, if the electric vehicle 1 includes the PTO device 9, the transmission system 3 according to some embodiments may further include the PTO axis 38, a PTO axis flange 39, and a PTO gear PG.

The PTO axis 38 may connect the transmission system 3 to the PTO device 9 and may transmit the power of the driving motor 4 to the PTO device 9 rather than the differential device 6. For example, as shown in FIG. 3, the PTO gear PG is mounted on an outer surface of the PTO axis 38 and the PTO gear PG may be selectively connected to any one of the plurality of input gears IG (e.g., the fourth input gear IG4). In this case, the output gear OG may not include an output gear (e.g., the fourth output gear OG4) corresponding to the input gear IG.

The PTO axis flange 39 may accommodate and support the PTO axis 38 and support the PTO axis 38 on other elements. For example, as shown in FIG. 2, the PTO axis flange 39 may be on the opposite side of the motor flange 33 of the housing 31.

A transmission assembly 10 according to some embodiments is a transmission system for an electric vehicle and may feedback control the positions of a plurality of shift forks 300 such that a synchronizer 400 is connected to the output axis 36 at a correct position.

The transmission assembly 10 according to some embodiments may include the transmission actuator 100, the rotation axis 200, the shift fork 300, the synchronizer 400, the position sensor 500, the jig 600, and a shift rail 700.

The transmission actuator 100 may be connected to the rotation axis 200 and receive a control signal from the controller 8 to rotate the rotation axis 200 and move the shift fork 300. When the transmission actuator 100 drives the rotation axis 200 to move the shift fork 300, and then the controller 8 transmits a correction signal to the transmission actuator 100, the transmission actuator 100 may rotate in the forward or reverse direction again to correct the position of the shift fork 300. The rotation direction of the transmission actuator 100 that received the correction signal may be the same as or opposite to the rotation direction of the transmission actuator 100. For example, if the rotation direction of the transmission actuator 100 that received the transmission signal is clockwise (or a forward direction), the rotation direction of the transmission actuator 100 that received the correction signal may be clockwise or counterclockwise (or a reverse direction). For example, as shown in FIG. 4, the transmission actuator 100 may be arranged at an end of the rotation axis 200 and be connected to rotation axis gears 211 and 221 (hereinafter, also referred to as a first rotation axis gear 211 and a second rotation axis gear 221) of the rotation axis 200 through actuator gears 111 and 121 (hereinafter, also referred to as a first actuator gear 111 and a second actuator gear 121). For example, the transmission actuator 100 may include an electric motor.

The transmission actuator 100 may include a plurality of transmission actuators 100. For example, as shown in FIG. 4, the transmission actuator 100 may include the first transmission actuator 110 and the second transmission actuator 120. The first transmission actuator 110 may be connected to the first rotation axis 210, and the second transmission actuator 120 may be connected to the second rotation axis 220. The first transmission actuator 110 and the second transmission actuator 120 may receive a control signal from the controller 8 and operate independently from each other. The first transmission actuator 110 may include a first actuator gear 111 connected to a first rotation axis gear 211 of the first rotation axis 210, and the second transmission actuator 120 may include a second actuator gear 121 connected to a second rotation axis gear 221 of the second rotation axis 220.

The rotation axis 200 may be connected to the transmission actuator 100 and the shift fork 300. When the transmission actuator 100 operates, the rotation axis 200 rotates and the shift fork 300 connected to the rotation axis 200 may move in a longitudinal direction of the rotation axis 200. For example, the rotation axis 200 may extend in a first direction (e.g., an X-axis direction of FIG. 4). The rotation axis 200 may include rotation axis bodies 213 and 223 (hereinafter, also referred to as a first rotation axis body 213 and a second rotation axis body 223) extending in a first direction, the rotation axis gears 211 and 221 provided at a first end (e.g., an end on the transmission actuator 100 side) of the rotation axis bodies 213 and 223, and worm gears 212 and 222 (hereinafter, also referred to as a first worm gear 212 and a second worm gear 222) provided on an outer surface of the rotation axis bodies 213 and 223 and connected to the rack gears 312 and 322 (hereinafter, also referred to as a first rack gear 312 and a second rack gear 322) of the shift fork 300.

The rotation axis 200 may include a plurality of rotation axes 200. For example, as shown in FIG. 4, the plurality of rotation axes 200 may include the first rotation axis 210 and the second rotation axis 220. The first rotation axis 210 may be connected to the first transmission actuator 110 and the first shift fork 310. The first rotation axis 210 may include the first rotation axis body 213 extending in a first direction, the first rotation axis gear 211 connected to the first actuator gear 111 of the first transmission actuator 110 and arranged in a first end of the first rotation axis body 213, and the first worm gear 212 on an outer surface of the first rotation axis body 213 and engaged with the first rack gear 312 of the first shift fork 310.

The second rotation axis 220 may be connected to the second transmission actuator 120 and the second shift fork 320. The second rotation axis 220 may include the second rotation axis body 223 extending in the first direction, the second rotation axis gear 221 connected to the second actuator gear 121 of the second transmission actuator 120 and arranged in a first end of the second rotation axis body 223, and the second worm gear 222 arranged on the outer surface of the second rotation axis body 223 and engaged with the second rack gear 322 of the second shift fork 320.

The first rotation axis 210 and the second rotation axis 220 may be parallel to each other. For example, as shown in FIG. 4, the first rotation axis 210 and the second rotation axis 220 may extend parallel to each other in the first direction and be apart from each other in a second direction. The ends of the plurality of shift forks 300 at the sides of the rack gears 312 and 322 may be arranged between the first rotation axis 210 and the second rotation axis 220, such that the size of the transmission assembly 10 may be reduced in the second direction (e.g., in the height direction of the transmission assembly 10 or the Z-axis direction of FIG. 4).

The first worm gear 212 and the second worm gear 222 may be formed at different positions in the first direction. For example, as shown in FIG. 4, the first worm gear 212 and the second worm gear 222 may be apart from each other in the first direction. Therefore, when the transmission actuator 100 operates, the plurality of shift forks 300 may not interfere with each other. For example, the first worm gear 212 may be apart from the second worm gear 222 in the first direction such that the first shift fork 310 and the second shift fork 320 are apart from each other while remaining in closest proximity.

The shift fork 300 may be connected to the rotation axis 200 and support the synchronizer 400. The shift fork 300 may be selectively engaged with the input gear IG by moving the synchronizer 400 while being moved by the rotation axis 200. The synchronizer 400 may be supported by the shift fork 300 and may move together with the shift fork 300. For example, as shown in FIG. 4, the shift fork 300 may include shift fork bodies 311 and 321 (hereinafter, also referred to as a first shift fork body 311 and a second shift fork body 321) supporting the synchronizer 400 and the rack gears 312 and 322 at first ends of the shift fork bodies 311 and 321. The rack gears 321 and 322 may be engaged with the worm gears 212 and 222 of the rotation axis 200. When the rotation axis 200 rotates, the rack gears 312 and 322 may move along the worm gears 212 and 222, thereby allowing the shift fork 300 to move. The shift fork 300 may be supported by the shift rail 700 in the first direction. For example, as shown in FIG. 4, the shift rail 700 extending in the first direction may be inserted into the first ends of the shift fork bodies 311 and 321, and the shift fork 300 may move in the first direction along the shift rail 700.

The shift fork 300 may be connected to the jig 600. For example, as shown in FIG. 4, the jig 600 may be mounted on a surface (e.g., the upper surface of FIG. 4) of the shift fork bodies 311 and 321. The jig 600 may move in the first direction together with the shift fork 300. Therefore, the position sensor 500 may detect the position of the jig 600 and, based on the detection, detect the position of the shift fork 300.

The shift fork 300 may include a plurality of shift forks 300. For example, the plurality of shift forks 300 may include the first shift fork 310 and the second shift fork 320. The first shift fork 310 may include the first shift fork body 311 supporting the first synchronizer 410 and the first rack gear 312 formed at the first end of the first shift fork body 311. A first jig 610 may be mounted on the upper surface of the first shift fork body 311. The first shift fork body 311 may have a Y or U shape including a groove, and the first synchronizer 410 may be supported in the groove. When the first transmission actuator 110 operates and the first rotation axis 210 rotates, the first shift fork 310 moves in the first direction, and the first synchronizer 410 moves and is selectively engaged with one of the plurality of input gears IG, such that a transmission operation may occur.

The second shift fork 320 may include the second shift fork body 321 supporting the second synchronizer 420 and the second rack gear 322 formed at the second end of the second shift fork body 321. For example, as shown in FIG. 4, the second rack gear 322 and the first rack gear 312 may face directions (e.g., the +−Z axis directions, respectively) opposite to each other. A second jig 620 may be mounted on the upper surface of the second shift fork body 321. The second shift fork body 321 may have a Y or U shape including a groove, and the second synchronizer 420 may be supported in the groove. When the second transmission actuator 120 operates and the second rotation axis 220 rotates, the second shift fork 320 moves in the first direction, and the second synchronizer 420 moves and is selectively engaged with one of the plurality of input gears IG, such that a transmission operation may occur.

The synchronizer 400 may be selectively engaged with the plurality of input gears IG to perform a transmission operation. The synchronizer 400 may be selectively engaged with the plurality of input gears IG mounted on the output axis 36, thereby changing the rotation speed of the output axis 36 and transmitting the changed rotation speed to the differential device 6. The synchronizer 400 may be supported by the shift fork 300 and selectively engaged with the plurality of input gears IG while moving together with the shift fork 300.

The synchronizer 400 may include hubs 411 and 421 (hereinafter, also referred to as a first hub 411 and a second hub 421), outer clutches 412 and 422, and inner clutches 413 and 423. The hubs 411 and 421 may be supported by the shift fork bodies 311 and 321 of the shift fork 300 and may support the outer clutches 412 and 422 and the inner clutches 413 and 423. For example, as shown in FIG. 4, the hubs 411 and 421 have a cylindrical shape and the outer sides thereof may be supported by the shift fork bodies 311 and 321. The outer clutches 412 and 422 and the inner clutches 413 and 423 may respectively be supported in the inner side of the hubs 411 and 421. The outer clutches 412 and 422 and the inner clutches 413 and 423 may be selectively engaged with the plurality of input gears IG as the synchronizer 400 moves, thereby performing a transmission operation. The outer clutches 412 and 422 and the inner clutches 413 and 423 may have different diameters and widths. For example, as shown in FIG. 4, the inner clutches 413 and 423 may be accommodated inside the outer clutches 412 and 422. In addition, the outer clutches 412 and 422 may have greater widths than those of the inner clutches 413 and 423. When the synchronizer 400 moves to one side, the outer clutches 412 and 422 or the inner clutches 413 and 423 may be engaged with one of the plurality of input gears IG, and when the synchronizer 400 moves to the opposite side, the inner clutches 413 and 423 or the outer clutches 412 and 422 may be engaged with one of the plurality of input gears IG. For example, as shown in FIG. 3, when the synchronizer 400 moves in one direction, the outer clutches 412 and 422 or the inner clutches 413 and 423 may be engaged with the first input gear IG1 and/or the third input gear IG3, and when the synchronizer 400 moves in the opposite direction, the outer clutches 412 and 422 or the inner clutches 413 and 423 may be engaged with the second input gear IG2 and/or the fourth input gear IG4.

The synchronizer 400 may include a plurality of synchronizers 400. For example, the plurality of synchronizers 400 may include the first synchronizer 410 and the second synchronizer 420. The first synchronizer 410 may include a first hub 411 supported by the first shift fork body 311 and a first outer clutch 412 and a first inner clutch 413 on the inner side of the first hub 411. The first hub 411 may have a ring or a hollow cylindrical shape and the outer surface thereof may be supported by the inner surface of the first shift fork body 311. The first outer clutch 412 and the first inner clutch 413 may be supported on the inner side of the first hub 411. While the first synchronizer 410 moves together with the first shift fork 310, the first outer clutch 412 or the first inner clutch 413 may be selectively engaged with one of the plurality of input gears IG.

The first synchronizer 410 may include a first hub 411 supported by the first shift fork body 311 and a first outer clutch 412 and a first inner clutch 413 on the inner side of the first hub 411. The first hub 411 may have a ring or hollow cylindrical shape and the outer surface thereof may be supported by the inner surface of the first shift fork body 311. The first outer clutch 412 and the first inner clutch 413 may be supported on the inner side of the first hub 411. While the first synchronizer 410 moves together with the first shift fork 310, the first outer clutch 412 or the first inner clutch 413 may be selectively engaged with one of the plurality of input gears IG.

The second synchronizer 420 may include a second hub 421 supported by the second shift fork body 321 and a second outer clutch 422 and a second inner clutch 423 on the inner side of the second hub 421. The second hub 421 may have a ring or a hollow cylindrical shape and the outer surface thereof may be supported by the inner surface of the second shift fork body 321. The second outer clutch 422 and the second inner clutch 423 may be supported on the inner side of the second hub 421. While the second synchronizer 420 moves together with the second shift fork 320, the second outer clutch 422 or the second inner clutch 423 may be selectively engaged with one of the plurality of input gears IG.

The position sensor 500 may be connected to the controller 8 either wired or wirelessly and may detect and transmit, to the controller 8, the position of the shift fork 300. The position sensor 500 may be accommodated and/or supported in the sensor box 32. The position sensor 500 may include a fixed portion and a moving portion. The fixed portion may be supported by the sensor box 32 and may not move even when the shift fork 300 moves. The above moving portion may move together with the shift fork 300. For example, the position sensor 500 may be a fixed portion of which both ends are supported in the first direction (or the X-axis direction of FIG. 4) by the sensor box 32, and a portion of the position sensor 500 inserted into the jig 600 may include a moving portion. The position sensor 500 may detect and transmit, to the controller 8, the position of the jig 600 moved by the shift fork 300. For example, the position sensor 500 may include a linear variable displacement transducer (LVDT) sensor. The position sensor 500 may be connected to the jig 600 and include a movable core that may be moved by the jig 600 and a plurality of coils surrounding the movable core. An AC voltage may be applied to a primary coil among the plurality of coils, and an induced voltage by electromagnetic induction may be applied to secondary coils arranged on both sides of the primary coil. And when the jig 600 moves, causing the movable coil to move, the voltage of one of the secondary coils increases and decreases, and, based on a voltage difference between the two secondary coils, the position sensor 500 may detect the position and movement direction of the movable core and the jig 600 connected to the movable core. The operating principle of the LVDT sensor is the same as that of the known LVDT sensor, and thus, detailed descriptions thereof are omitted.

The jig 600 may be connected to the shift fork 300 and at least a portion of the position sensor 500 may be inserted into the jig 600. The jig 600 may move together with the shift fork 300, and the position sensor 500 may detect the position of the jig 600 to obtain position data of the shift fork 300. The jig 600 may be a reference for the position of the shift fork 300 and the controller 8 may determine the current position of the shift fork 300 based on the position of the jig 600 detected by the position sensor 500 to determine whether the synchronizer 400 is appropriately connected to the input gear IG. The jig 600 may be mounted on the side of the shift fork 300, may extend in the second direction (e.g., the Z-axis direction of FIG. 4 or the height direction of the transmission assembly 10), and include a hole in an upper portion thereof. A position sensor 500 may be inserted into the above hole. The jig 600 may be connected to at least a portion of the position sensor 500 (e.g., the movable core). The jig 600 may include a plurality of jigs 600. For example, as shown in FIG. 4, the jig 600 may include the first jig 610 connected to the first shift fork 310 and the second jig 620 connected to the second shift fork 320.

The shift rail 700 may be inserted into the shift fork 300 and may guide the movement of the shift fork 300. For example, as shown in FIG. 4, the shift rail 700 may have a rod shape extending in the first direction (e.g., the X-axis direction of FIG. 4 or the longitudinal direction of the transmission assembly 10). The shift rail 700 may be inserted into the shift fork 300 and may prevent the shift fork 300 from moving in a different direction or deviating from the rotation axis 200 as the rotation axis 200 rotates. For example, the shift rail 700 may be inserted into the plurality of shift forks 300 (e.g., the first shift fork 310 and the second shift fork 320). The shift rail 700 may be inserted into a plurality of shift forks 300 and both ends thereof may protrude in the longitudinal direction toward the outside of the plurality of shift forks 300.

A transmission method of the transmission system according to some embodiments is described below.

As shown in FIG. 6, when the transmission system 3 determines that transmission is necessary based on a user's instruction or a pre-stored program or algorithm, the transmission system 3 transmits a control signal to the transmission actuator 100. When the transmission actuator 100 which received the control signal operates (rotates), the shift fork 300 moves while the rotation axis 200 rotates. And the synchronizer 400 supported by the shift fork 300 moves toward the input gear IG. Then, the position sensor 500 detects the position of the jig 600 moved by the shift fork 300, and, based on the detection, detects and transmits, to the controller 8, the position of the shift fork 300. The controller 8 may compare the detected position value of the shift fork 300 with a pre-stored reference position value. Here, the pre-stored reference position value may be the position value of the shift fork 300 where it may be determined that the synchronizer 400 is properly engaged with the plurality of input gears IG when a transmission signal is input. If the controller 8 determines that the position value of the detected shift fork 300 deviates from the reference position value, the controller 8 transmits a correction signal to the transmission actuator 100. When the transmission actuator 100 which received the control signal operates (rotates), the shift fork 300 moves while the rotation axis 200 rotates. And the synchronizer 400 supported by the shift fork 300 moves toward the input gear IG. Then, the position sensor 500 detects the position of the jig 600 moved by the shift fork 300, and, based on the detection, detects and transmits, to the controller 8, the position of the shift fork 300. The controller 8 may compare the detected position value of the shift fork 300 with a pre-stored reference position value. The controller 8 may determine that the transmission is finished when it is determined that the position value of the detected shift fork 300 matches the reference position value.

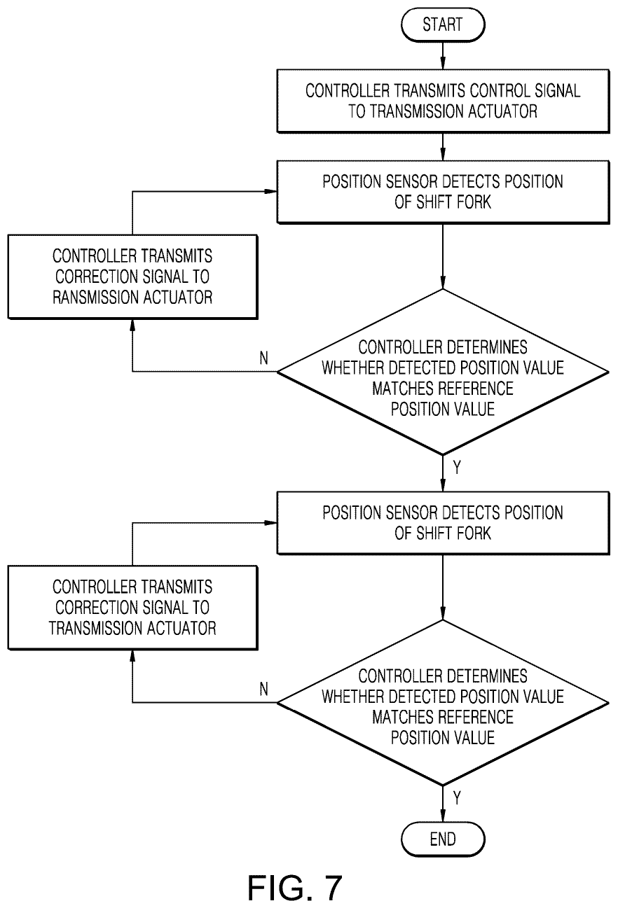

As shown in FIG. 7, the transmission method of the transmission system according to some embodiments may further include detecting, by the rotation sensor 61, the rotation speed of the output axis 36, and determining, by the controller 8, whether the detected rotation speed value matches the reference rotation speed value. If the detected rotation speed value deviates from the reference rotation speed value, the controller 8 may again transmit a correction signal to the transmission actuator 100. The transmission actuator 100 that received the correction signal may operate (rotate) again to move the shift fork 300 and the synchronizer 400, the rotation sensor 61 may detect the rotation speed of the output axis 36, and the controller 8 may determine whether the detected rotation speed value matches the reference rotation speed value. If the detected rotation speed value matches the reference rotation speed value, the controller 8 may determine that the transmission is finished. That is, the transmission method of the transmission system according to some embodiments may allow the controlling of the transmission operation of the transmission system 3 more precisely by adding rotation speed feedback control by the rotation sensor 61 in addition to the position feedback control by the position sensor 500.

The operation of the transmission system 3 according to some embodiments will be described in more detail.

FIG. 5 illustrates a state in which the controller 8 does not transmit the transmission signal to the transmission actuator 100, and in which the first transmission actuator 110 and the second transmission actuator 120 does not operate. In this state, the first synchronizer 410 and the second synchronizer 420 may not be engaged with the plurality of input gears IG and be in a neutral (N-speed) state.

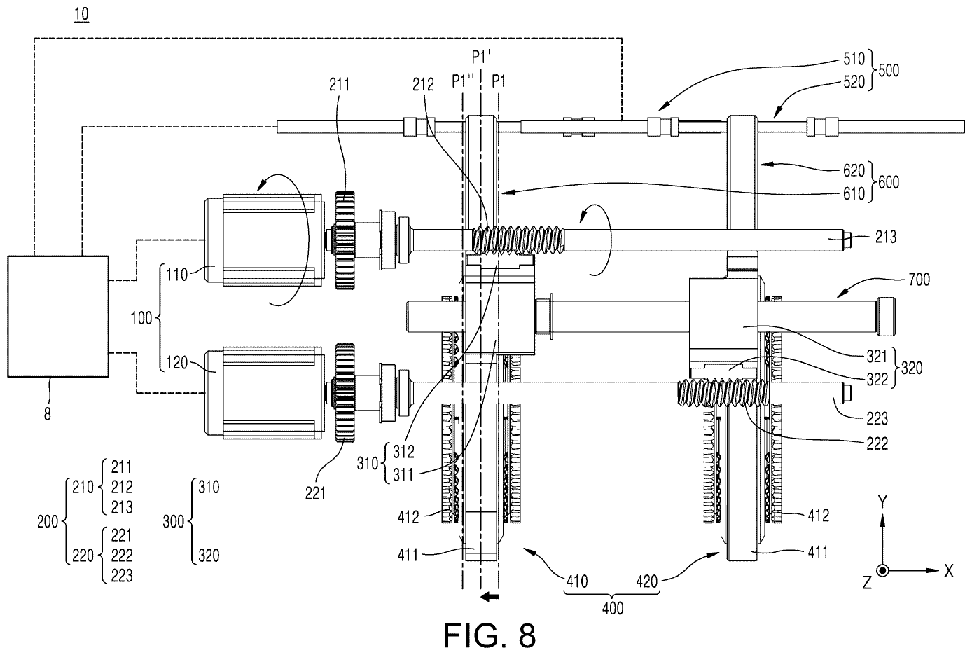

As shown in the following FIG. 8, the controller 8 may transmit a transmission signal to the first transmission actuator 110 for 1-speed transmission. As the first transmission actuator 110 rotates counterclockwise and the first rotation axis 210 also rotates counterclockwise, the first shift fork 310 meshed with the first worm gear 212 of the first rotation axis 210 may move in the first direction toward the first transmission actuator 110. And the first synchronizer 410 supported by the first shift fork 310 may move toward the first input gear IG1. Here, the initial position of the first shift fork 310 is P1, the reference position for the first shift fork 310 to be engaged with the first input gear IG1 is P1″, and the position to which the first shift fork 310 actually moved is P1″. The first position sensor 510 may detect the position of the first jig 610 mounted on the first shift fork 310 and, based on the detection, may detect and transmit, to the controller 8, the position of the first shift fork 310. The controller 8 may determine whether P1′ is the same as P1″ (i.e., determine whether an engagement depth of the first shift fork 310 matches a reference engagement depth), and, if so, may determine that the transmission is finished. The controller 8 may transmit a correction signal to the first transmission actuator 110 if P1′ is not the same as P1″. For example, if P1′ does not reach P1″, the controller 8 may transmit a correction signal such that the first transmission actuator 110 rotates further in the counterclockwise direction. Alternatively, if P1′ exceeds P1″, the controller 8 may transmit a correction signal such that the first transmission actuator 110 rotates in the clockwise direction.

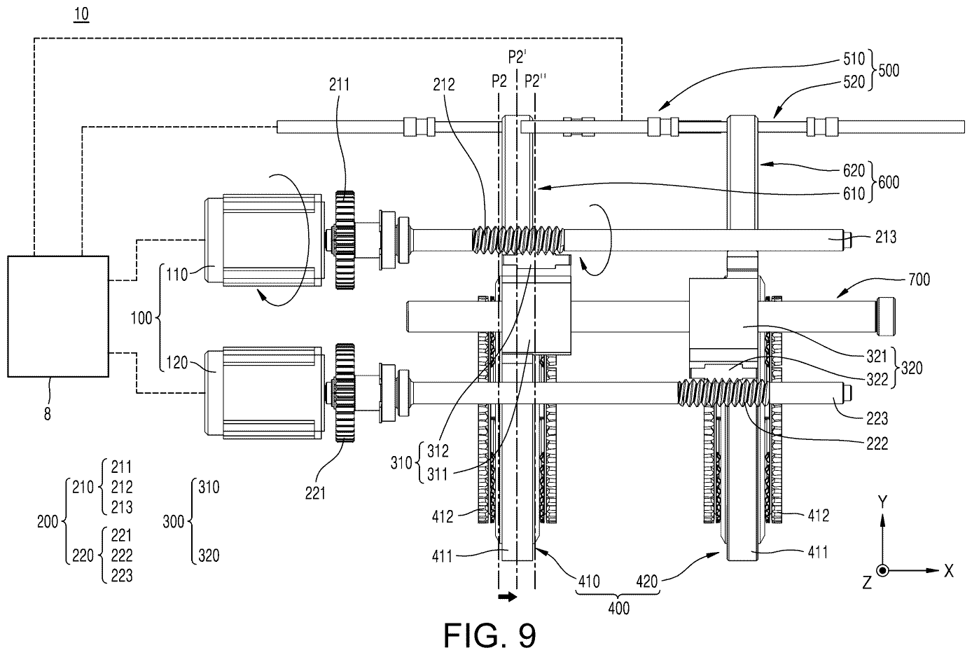

As shown in the following FIG. 9, the controller 8 may transmit a transmission signal to the first transmission actuator 110 for 2-speed transmission. As the first transmission actuator 110 rotates clockwise and the first rotation axis 210 also rotates clockwise, the first shift fork 310 meshed with the first worm gear 212 of the first rotation axis 210 may move in the first direction away from the first transmission actuator 110. And the first synchronizer 410 supported by the first shift fork 310 may move toward the second input gear IG2. Here, the initial position of the first shift fork 310 is P2, the reference position for the first shift fork 310 to be engaged with the second input gear IG2 is P1″, and the position to which the first shift fork 310 actually moved is P2′. The first position sensor 510 may detect the position of the first jig 610 mounted on the first shift fork 310 and, based on the detection, detect and transmit, to the controller 8, the position of the first shift fork 310. The controller 8 may determine whether P2′ is the same as P2″ (i.e., determine whether an engagement depth of the second shift fork 320 matches a reference engagement depth), and, if so, determine that the transmission is finished. The controller 8 may transmit a correction signal to the first transmission actuator 110 if P2′ is not the same as P2″. For example, if P2′ does not reach P2″, the controller 8 may transmit a correction signal such that the first transmission actuator 110 rotates further in the clockwise direction. Alternatively, if P2′ does not reach P2″, the controller 8 may transmit a correction signal such that the first transmission actuator 110 rotates in the counterclockwise direction.

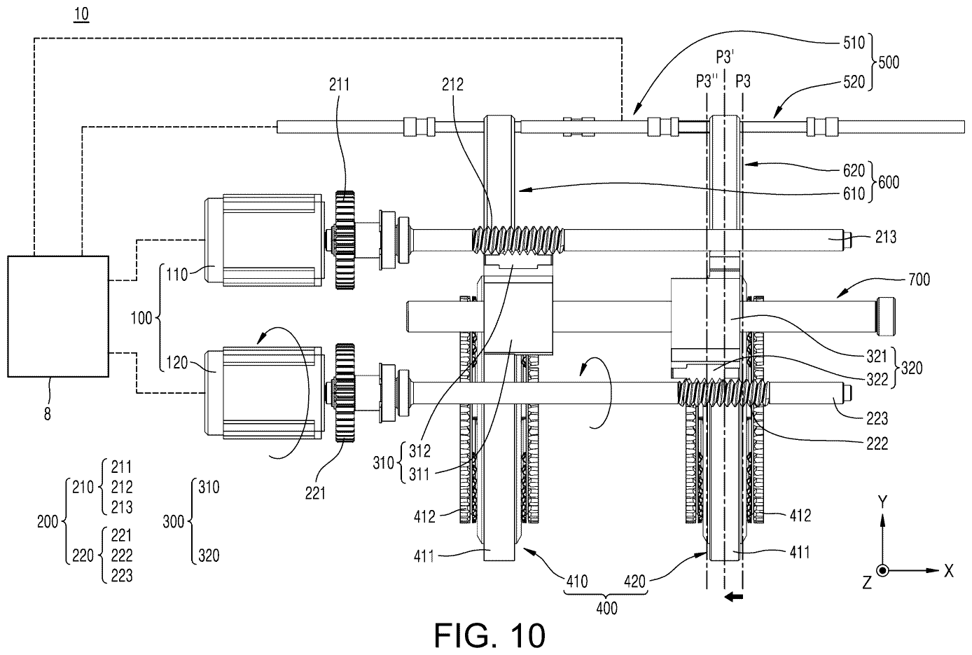

As shown in the following FIG. 10, the controller 8 may transmit a transmission signal to the second transmission actuator 120 for 3-speed transmission. As the second transmission actuator 120 rotates counterclockwise and the second rotation axis 220 also rotates counterclockwise, the second shift fork 320 meshed with the second worm gear 222 of the second rotation axis 220 may move in the first direction toward the second transmission actuator 120. And the second synchronizer 420 supported by the second shift fork 320 may move toward the third input gear IG3. Here, the initial position of the second shift fork 320 is P3, the reference position for the second shift fork 320 to be engaged with the third input gear IG3 is P3″, and the position to which the second shift fork 320 actually moved is P3′. The second position sensor 520 may detect the position of the second jig 620 mounted on the second shift fork 320 and, based on the detection, detect and transmit, to the controller 8, the position of the second shift fork 320. The controller 8 may determine whether P3′ is the same as P3″ (i.e., determine whether an engagement depth of the third shift fork 330 matches a reference engagement depth), and, if so, determine that the transmission is finished. The controller 8 may transmit a correction signal to the second transmission actuator 120 if P3′ is not the same as P3″. For example, if P3′ does not reach P3″ the controller 8 may transmit a correction signal such that the second transmission actuator 120 rotates further in the counterclockwise direction. Alternatively, if P3′ exceeds P3″, the controller 8 may transmit a correction signal such that the second transmission actuator 120 rotates in the clockwise direction.

As shown in the following FIG. 11, the controller 8 may transmit a transmission signal to the second transmission actuator 120 for 4-speed transmission. As the second transmission actuator 120 rotates clockwise and the second rotation axis 220 also rotates clockwise, the second shift fork 320 meshed with the second worm gear 222 of the second rotation axis 220 may move in the first direction away from the second transmission actuator 120. And the second synchronizer 420 supported by the second shift fork 320 may move toward the fourth input gear IG4. Here, the initial position of the second shift fork 320 is P4, the reference position for the second shift fork 320 to be engaged with the third input gear IG3 is P4″, and the position to which the second shift fork 320 actually moved is P4′. The second position sensor 520 may detect the position of the second jig 620 mounted on the second shift fork 320 and, based on the detection, may detect and transmit, to the controller 8, the position of the second shift fork 320. The controller 8 may determine whether P4′ is the same as P4″ (i.e., determine whether an engagement depth of the fourth shift fork 340 matches a reference engagement depth), and, if so, determine that the transmission is finished. The controller 8 may transmit a correction signal to the second transmission actuator 120 if P4′ is not the same as P4″. For example, if P4′ does not reach P4″, the controller 8 may transmit a correction signal such that the second transmission actuator 120 rotates further in the counterclockwise direction. Alternatively, if P4′ exceeds P4″, the controller 8 may transmit a correction signal such that the second transmission actuator 120 rotates in the clockwise direction.

As shown in the following FIG. 12, the controller 8 may transmit a transmission signal to both the first transmission actuator 110 and the second transmission actuator 120 for P-speed transmission. For example, when the first transmission actuator 110 and the second transmission actuator 120 rotate counterclockwise and the first rotation axis 210 and the second rotation axis 220 also rotate counterclockwise, the first shift fork 310 and the second shift fork 320 may move in the first direction toward the first transmission actuator 110 and the second transmission actuator 120, respectively. In addition, the first synchronizer 410 may move toward the first input gear IG1, and the second synchronizer 420 may move toward the third input gear IG3. The first position sensor 510 and the second position sensor 520 may detect the positions of the first jig 610 and the second jig 620, and, based on the detection, may detect and transmit, to the controller 8, the positions of the first shift fork 310 and the second shift fork 320. The controller 8 may determine whether P1′ is the same as P1″ and P3′ is the same as P3″ (i.e., determines whether the engagement depths of the first shift fork 310 and the third shift fork 330 match the reference engagement depth), and, if so, it may be determined that the transmission is finished. The controller 8 may transmit a correction signal to the first transmission actuator 110 and/or the second transmission actuator 120 if P1′ and P1″ are not the same or P3′ and P3″ are not the same as each other. For example, if P1′ or P3′ does not reach P1″ or P3″, the controller 8 may transmit a correction signal such that the first transmission actuator 110 or the second transmission actuator 120 further rotates in the counterclockwise direction. Alternatively, if P1′ or P3′ exceeds P1″ or P3″, the controller 8 may transmit a correction signal such that the first transmission actuator 110 or the second transmission actuator 120 rotates in the clockwise direction.

Alternatively, the controller 8 may determine whether the rotation speed of the output axis 36 detected by the rotation sensor 61 is the same as the pre-stored reference rotation speed value of the output axis 36 when the position value of the shift fork 300 detected at each speed transmission is the same as the pre-stored reference position value of the shift fork 300. If the rotation speed of the detected output axis 36 is not the same as the reference rotation speed value of the output axis 36 corresponding to each speed transmission, the controller 8 may again transmit a correction signal to the corresponding transmission actuator 100. When the rotation speed of the detected output axis 36 is the same as the reference rotation speed value of the output axis 36 corresponding to each speed transmission, the controller 8 may finish the transmission operation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A transmission system comprising:
an output axis;
a plurality of input gears mounted on the output axis;
a transmission assembly configured to selectively engage with the plurality of input gears; and
a controller, wherein
the transmission assembly comprises:
a plurality of transmission actuators comprising a first transmission actuator and a second transmission actuator;
a plurality of rotation axes comprising a first rotation axis connected to the first transmission actuator and a second rotation axis connected to the second transmission actuator, the plurality of axes each extending in a first direction;
a plurality of shift forks comprising a first shift fork connected to the first rotation axis and a second shift fork connected to the second rotation axis;
a plurality of synchronizers comprising a first synchronizer supported by the first shift fork and configured to selectively engage with the plurality of input gears and a second synchronizer supported by the second shift fork and configured to selectively engage with the plurality of input gears; and
a plurality of position sensors comprising a first position sensor configured to detect a position of the first shift fork and a second position sensor configured to detect a position of the second shift fork, and
wherein the controller is configured to compare a position value of the plurality of shift forks detected by the plurality of position sensors and a predetermined reference position value and, when the detected position value does not match the reference position value, transmit a correction signal to at least one of the plurality of transmission actuators,
the transmission assembly further comprises a plurality of jigs comprising a first jig connected to and configured to move together with the first shift fork and a second jig connected to and configured to move together with the second shift fork,
the plurality of position sensors are configured to detect a position of each of the plurality of jigs to detect a position of the plurality of shift forks,
the plurality of position sensors comprise a linear variable displacement transducer (LVDT) sensor, and
the plurality of position sensors each comprise:
a core movable together with the jig; and
a plurality of coils that are not moved by the jig and surround the core.

2. (canceled)

3. The transmission system of claim 1, further comprising:
a housing; and
a plurality of sensor boxes mounted on the housing and accommodating the plurality of position sensors.

4. (canceled)

5. A method of controlling a transmission system, the method comprising:
transmitting, by a controller, a transmission signal to a transmission actuator;
selectively engaging, by the transmission actuator, a synchronizer supported by a shift fork with a plurality of input gears mounted on an output axis;
detecting, by a position sensor connected to the shift fork, a position of the shift fork;
comparing, by the controller, a position value of the shift fork detected by the position sensor and a predetermined reference position value; and
transmitting, by the controller, a correction signal to the transmission actuator when the detected position value does not match the reference position value, wherein,
in the transmitting of the correction signal to the transmission actuator,
when the detected position value of the shift fork is less than the predetermined reference position value, the controller is configured to transmit the correction signal to the transmission actuator such that the transmission actuator rotates in a same direction as the transmission signal, and,
when the detected position value of the shift fork is greater than the predetermined reference position value, the controller is configured to transmit the correction signal to the transmission actuator such that the transmission actuator rotates in an opposite direction to the transmission signal.
